(19) United States
(12) Patent Application Publication
(10) Pub. No.: US 2005/0055194 A1
(43) Pub. Date: Mar. 10, 2005

(54) Migration model

(76) Inventors: Luanne Marie Krause, Brooklyn Parks, MN (US); Webb Edwards, Scottsdale, AZ (US); Beverly Jean Schwalbach, Lake Elmo, MN (US)

Correspondence Address: GLENN PATENT GROUP, 3475 EDISON WAY, SUITE L, MENLO PARK, CA, 94025, US

(21) Appl. No.: 10/658,783

(22) Filed: Sep. 8, 2003

(51) Int. Cl. G06F 9/45

(52) U.S. Cl. 703/22

(57) ABSTRACT

An apparatus and process for a migration model is provided that simulates impacts of various industry triggers, such as for example debit card products and online financial services, on aggregated costs and revenues associated with the traditional products and services, such as the traditional use of checks. The migration model apparatus and process provides an interactive tool for the simulation and analysis of the impact of new or existing triggers. The tool is interactive and allows a user to select from one or more triggers and to base the impact analysis on the interaction of the selected triggers with user defined parameters. The migration model apparatus and process provides a knowledge management system, whereby a user can define new triggers, which are then reviewed by application administrators and subsequently added to a library of triggers for use in future analysis and/or developing new triggers based on the existing trigger library.

### BACKGROUND OF THE INVENTION

1. Technical Field

The invention relates generally to computerized impact analysis. More particularly, the invention relates to an interactive tool with which users can quickly and accurately predict that effects triggers have on existing revenue infrastructure, such as volumes, costs, and revenues from the enterprise level down to the branch level.

2. Description of the Prior Art

Advances in technology affect current volumes and revenues at many points along a value chain of a company or enterprise at ever increasing rates. Some of these effects are direct and easily predictable. Others are ripple effects of conflicting and/or complementing technologies.

Historical data mining techniques can be used to review the effects of a particular technology and can do so independently. However, attempts to factor in other changes can be difficult, as they typically require multiple queries and complex algorithms. Most of the attempts to review such changes ultimately lose creditability and accuracy due to invalid assumptions and/or missing technology factors.

An example of a challenging situation presents itself in the current payments environment. In such environment, the rate and magnitude of change requires financial institutions to plan and react with time-to-market windows that are shortening.

Another example is a transaction volume increase or decrease in an element of a financial institution's value chain having a ripple effect on the other elements in the value chain. For example, if point-of-sale check truncation transaction volumes grow steadily over the next few years, it is important for financial institutions to predict the impact on current volumes, revenues, and costs of paper and electronic products.

It has also been found that a financial institution's line-of-business, operations, and technology executives and managers need to be able to model current trends and “what if” scenarios to determine the financial impacts on paper and electronic elements in the financial institution's value chain.

Various techniques have been developed which address related issues, as follows.

A. R. Melchione, R. Martinez, E. Seifert, and M. Hirsch, Sales and marketing support system using a customer information database, U.S. Pat. No. 5,930,764 (Jul. 27, 1999) discloses a marketing tool used for segmenting data in order to target marketing based on internal and external data. The Melchione, et al teachings are sales target—and market-based, and does not disclose any knowledge management.

A. W. Ulwick, Computer based process for strategy evaluation and optimization based on customer desired outcomes and predictive metrics, U.S. Pat. No. 5,963,910 (Oct. 5, 1999) discloses a technique that is based on customer needs. Outcome goals are predefined and the predictor likelihood is applied as a percentage to see if the goals are met. Ulwick's technique can apply multiple goals and likelihood in one analysis. Ulwick builds knowledge through storing of previous analyses, but it should be appreciated that Ulwick's technique is goal driven in that analysis is applied to determine if predefined goals are met. Also, Ulwick's teachings are based on desired outcomes of multiple groups rather than based on the financial implications.

L. Honarvar, Decision management system for creating strategies to control movement of clients across categories, U.S. Pat. No. 6,321,206 (Nov. 20, 2001) discloses a technique which allows monitoring and evaluating client performance in their respective interactions with an organization. It also stratifies clients into groups and tracks marketing and other experiments. It also monitors for client movement between groups. Honarvar's technique is tracking based and does not have any knowledge management.

N. Kushmerick, S. Hanks, and D. Weld, An Algorithm for Probabilistic Planning, Artificial Intelligence (Apr. 13, 1994) disclose a technique which builds probability chains. The technique predicts an outcome of events based on the probability of multiple states and actions, based on mathematics and based on probabilities, as opposed to historical data. There are no cost and/or revenue projections taught or disclosed.

What is needed is a planning and evaluation tool to provide executives and managers of financial institutions with means to provide enterprise wide high quality information in support of both strategic and tactical decisions as they relate to proposed changes in the financial institution's environment.

It would therefore be advantageous to provide a migration model apparatus and process having predefined rules and triggers which allow a user to quickly make assumptions on the direct impacts of a particular technology, as well as the cursory impacts on other associated technologies.

It would further be advantageous to provide a migration model apparatus and process that serves as a knowledge repository. As users develop new triggers, based on impact analysis for example, such newly defined triggers are reviewed by system administrators and added to the repository for use in future analyses.

It would also be advantageous to provide an interactive tool with which users can quickly and accurately predict the effects new product triggers will have on existing volumes, costs, and revenues from the enterprise level all the way down to the branch level.

### SUMMARY OF THE INVENTION

An apparatus and process for a migration model is provided that simulates impacts of various industry triggers, such as for example debit card products and online financial services, on aggregated costs and revenues associated with the traditional products and services, such as the traditional use of checks. The migration model apparatus and process provides an interactive tool for the simulation and analysis of the impact of new triggers. The tool is interactive and allows a user to select from one or more triggers and to base the impact analysis on the interaction of the selected triggers with user defined parameters. The migration model apparatus and process provides a knowledge management system, whereby a user can define new triggers, which are then reviewed by application administrators and subsequently added to a library of triggers.

### BRIEF DESCRIPTION OF THE DRAWINGS

FIG. 1 is a schematic diagram of a logical architecture of the main components according to the invention.

FIG. 2 is an example of a Welcome page for an interactive application according to the invention;

FIG. 3 is an example Home Page for the application user view according to the invention;

FIG. 4 is an example Create/View Trigger page providing means for creating new triggers, and viewing and maintaining existing triggers according to the invention;

FIG. 5 is an example Trigger Detail page providing means for the user to create a new Trigger according to the invention;

FIG. 6 is an example Trigger View page, providing means for the user to view the parameters of a particular active or pending trigger according to the invention;

FIG. 7 is an example New Impact Analysis Request Page according to the invention;

FIG. 8 is an example first Impact Analysis Request Page providing means for the user to specify the parameters for a new Impact Analysis Request according to the invention;

FIG. 9 is an example second Impact Analysis Request Page providing the user functionality to view and delete a previously submitted Impact Analysis Request according to the invention;

FIG. 10 is an example Impact Analysis Results Page which provides the user a list of processed Impact Analysis Requests according to the invention;

FIG. 11 is an example Impact Analysis Result Details Page providing means for allowing the user to view analysis results according to the invention;

FIG. 12 is an example Trigger Results Users Page allowing the user to grant viewing permissions to other users of the application according to the invention;

FIG. 13 is an example Actual Data Views Page providing a list of processed Data View Requests according to the invention;

FIG. 14 is an example Actual Data View Request Detail page providing means for allowing the setup of a new Actual Data View Request according to the invention;

FIG. 15 is an example Actual Data View Result Page showing the results of a selected Actual Data View Request according to the invention;

FIG. 16 is an example Home Page (Administrator user view) according to the invention;

FIG. 17 is an example Administration Home Page for application administrators according to the invention;

FIG. 18 is an example Administration Users List Page providing a list of all users defined to the application according to the invention;

FIG. 19 is an example Administration User Detail page providing viewing and maintenance of an existing application user according to the invention;

FIG. 20 is an example Trigger Priority Page providing functionality to reorder the priority of existing application triggers according to the invention;

FIG. 21 is an example Administration Payment Segment Page providing viewing and maintenance of industry segment percentages within industry segment groups according to the invention; and

FIG. 22 is an example User Profile Page providing the application user the ability to view and maintain his or her profile information according to the invention.

### DETAILED DESCRIPTION OF THE INVENTION

An apparatus and process for a migration model is provided that simulates impacts of various industry triggers, such as for example debit card products and online financial services, on aggregated costs and revenues associated with the traditional products and services, such as the traditional use of checks. The migration model apparatus and process provides an interactive tool for the simulation and analysis of the impact of new triggers. The tool is interactive and allows a user to select from one or more triggers and to base the impact analysis on the interaction of the selected triggers with user defined parameters. The migration model apparatus and process provides a knowledge management system, whereby a user can define new triggers, which are then reviewed by application administrators and subsequently added to a library of triggers.

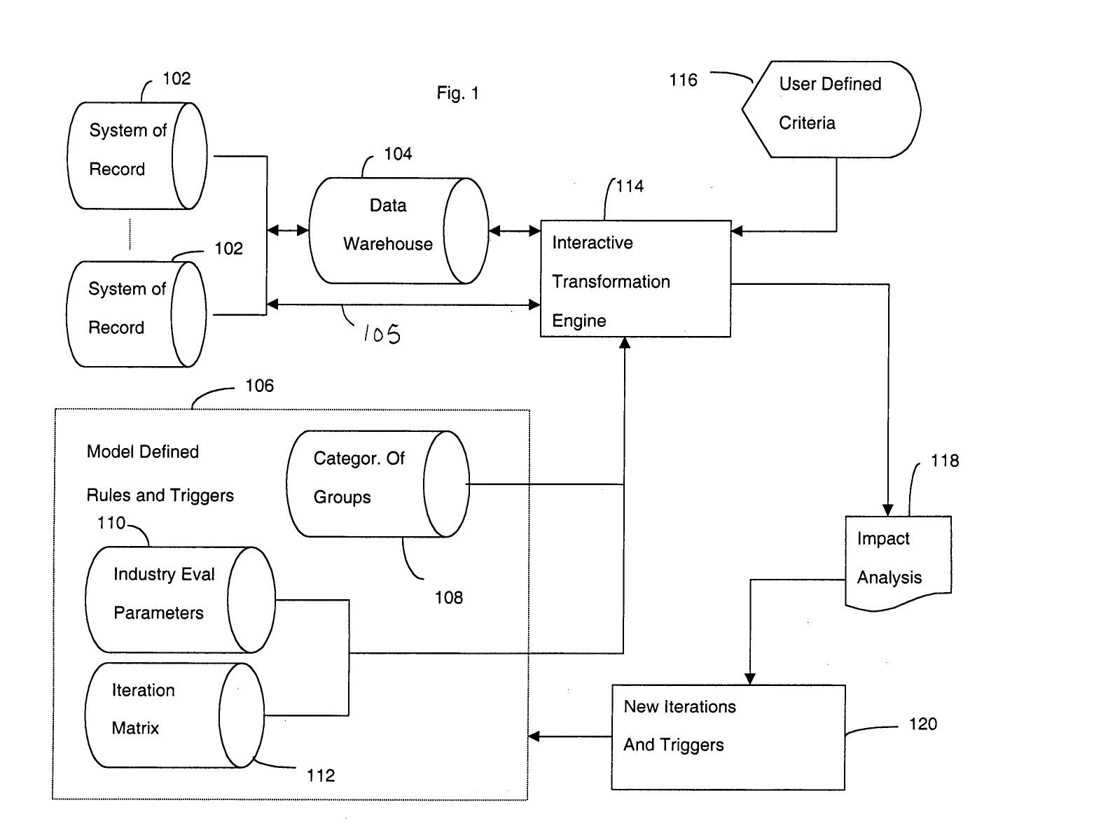

A preferred embodiment of the invention is described with reference to FIG. 1. FIG. 1 is a schematic diagram of a logical architecture of the main components and depicts a corresponding process flow according to the invention. All current information about transactions and related infrastructure are in existing systems of record 102. An enterprise may have more than one location for holding expenses and more than one system of record for holding revenues and volumes.

In one embodiment of the invention, all of the current environment information, referred to herein as baseline data, is tracked into a single data store or data warehouse 104, a convenient mechanism for baseline data. In another embodiment of the invention, the information collected and stored in the system of record 102 is accessed directly 105.

Model defined rules and triggers 106 provide the information that can be programmed for processing the data from the baseline data, i.e. from the data warehouse 104 or accessed directly 105. Model defined rules and triggers 106 comprises three fundamental dominant groups: categorization of groups of data 108, industry or external evaluation parameters 110, and the iteration matrix 112.

The first group is the categorization of groups of data 108. In the example of FIG. 1, the data is transactional data, such as paper checks. For example, the categorization group 108 may segment data based on how the data is routed, a geographic distribution, because the data might be influenced differently. In this case, a large bank may be structured as multiple separate banks based on region and state, resulting in the data warehouse being thus categorized by geography. Another example of categorization can be by type of customer, wholesale versus retail. Another example of categorization is by type of account, such as type of merchant account or type of resale account. Generally speaking, the categorization of groups 108 is a way to structure base line data into meaningful subsets.

The set of industry evaluation parameters 110 component is a representation of the external environment. That is, industry evaluation parameters 110 reflect a perception of external influences on the raw data. In the example of FIG. 1, the set of industry evaluation parameters 110 comprises two sets of information. One set is the distribution of transactions across types of merchants. For example, retail merchants physically bring to a bank a particular mix of transactions, which is factored into the model. The mix of transactions may be paper checks and credit cards. The mix of transactions can be used as representing payment behavior for an industry segment.

The industry evaluation parameters 110 are applied to the categorization of groups 108 for determining the industry evaluation parameters for a particular subset or group of data. For example, merchant customers of a particular bank may be 20% retail merchants and 80% manufacturing merchants. A change in the number of checks submitted to both of these customer sets obviously may be different. Thus, the migration model allows a bank to evaluate the impact of change on volume based on the nature of the customer set, as opposed to based purely on a growth prediction of the category percentage of a given volume.

The iteration matrix 112 component describes how a trigger interacts with the data. The iteration matrix 112 has trigger set up capability by indicating the types of behavior with which the trigger interacts and how the triggers interact with each other. For example, a user can select four or five things affecting an industry, that is, four or five triggers and sets forth which trigger is applied first, second, etc.

The interactive transformation engine 114 takes the raw data and the rules and brings them together by performing the corresponding calculations. In the example of FIG. 1, the interactive transformation engine 114 is viewed as a big matrix multiplier. Typically, the engine takes as input three, four, or five multidimensional sets of raw data, where, for example, one set of data represent the current state and another set of data may represent an interaction matrix, and performs the matrix mathematics.

The icon 116 is a display by which a user sets and resets the characteristics of the model for various simulations. The display icon 116 allows a user to modify a trigger, to make assumptions about a specific change in volume over a period of time, such as years, i.e. volume projection. It should be appreciated that by way of the display icon 116, the user can define criteria. The criteria are not programmed into software or set in hardware. A user is free to perform any type of analysis based on personal judgment. Also, a user is allowed to override system provided rules, if any.

The final product output from the interactive transformation engine 114 is the impact analysis 118. The output 118, representing analysis performed on the combination of the specially grouped raw data, applied external and industry evaluation parameters, and the iteration matrix, can be presented in a variety of formats, such as reports or on a screen. Regardless of format, the output describes the change in the underlying revenue, volume, and cost, based on assumptions that had been built into the model and provided by the user.

It should be appreciated that process is iterative. Based on the results of the first cycle of the impact analysis, a user can generate further analysis by adding new triggers and/or reorganizing existing triggers 120.

It should also be appreciated that the migration model apparatus and process provides a knowledge management subsystem. It gains knowledge with each trigger and/or with each iteration. That is, as each analysis is run, if a user decides that a particular trigger should be used for future analyses, for himself or for others, then that trigger can be incorporated into the model, so that the next person that runs the analysis can build off the former analysis.

In essence, the migration model apparatus and process is a multi-dimensional model that transforms raw data, based on the user's selection of industry influences, into a prediction of what the future state would be over time.

### An Ex mplary Migration Mod I

Overview

The described exemplary migration model is a migration model offering to application and administrator users a variety of functionality, comprising two of particular interest: a Trigger Impact module and an Actual Data View module.

The Trigger Impact module assesses the impact of one or more triggers on a user defined data sub-set and in accordance with user-defined assumptions and parameters. For purposes of this example, a trigger is defined as an initiative, either internal or external, which triggers the conversion of a paper check transaction to a paperless electronic transaction. The Migration Model comprises a database component which itself comprises a trigger table. The trigger table comprises both active and pending triggers, such triggers having any of the following attributes: a trigger name, description, service codes, industry codes, transactional segments to which a trigger is mapped, as well as a trigger priority for use when multiple triggers are used. For example, if Trigger 1's impact is calculated, then Trigger 2's impact is applied to the remaining results of Trigger 1.

It should be appreciated that the reference to conversion of a paper check transaction to a paperless electronic transaction is an example application of the model according to the invention. It should be emphasized that according to the invention a conversion of any type of transaction to any other type of transaction can be modeled.

The Actual Data View module allows the user to retrieve actual transaction data from the Model database by means of a query. The user provides the desired query parameters into a request screen and views the query results from a results screen.

It should be appreciated that this modeling tool takes advantage of and is based on a significant amount of data mining. That is, the data elements required by the modeling tool comprise live and real volume, revenue, and cost information for all products and for services integral to or touching upon the value chain. As much information as possible is captured as raw data at the source.

It should further be appreciated that the Migration Model provides means for obtaining information that is robust, timely, and accurate. It automates the extraction of information directly from sources wherever possible, enabling timeliness and accuracy of information, which is essential for the validation of the modeling results. The obtained data is descriptive not only of the products and sub-products, the processing centers, and the geographic entities, but data about customer relationships, customer segments, and industry segments are obtained as well. The concept of the modeling tool from a data perspective is that it relies on data being readily available from a data mart established for the purpose of supporting modeling tool operation. Hence, with information that is robust, timely, and accurate, the modeling tool's ability to manipulate data, perform messaging, and perform financial calculations can be customized to fit an institution's specific needs.

The modeling tool operates using variables from two main sources: user provided and those built in tables. The user of the modeling tool makes selections to specify the scope of a request, such as for example: geographic, an individual customer relationship or customer segment, industry segment, transaction types, evaluation time frames, and generic growth, etc., and to specify the variables or assumptions that control the model calculations. The remaining variables or parameters are available to the modeling tool in the form of tables maintained by the organization with responsibility for model administration. Examples of such remaining variables or parameters are those from previous analyses, established and approved triggers, etc.

A user of the modeling tool has options concerning how modeling tool output is displayed. In the Migration Model output is available in graphic or tabular form showing predicted volume, revenue, cost, and gross margins after impact. Results can be viewed as impacts, or predictive volumes after impacts are applied. The model database includes thirteen months of actual transaction data, which gives a user the option of viewing model results for a month, a total year, or annualized based on selected months.

Sample All-User Page.

Welcome Page

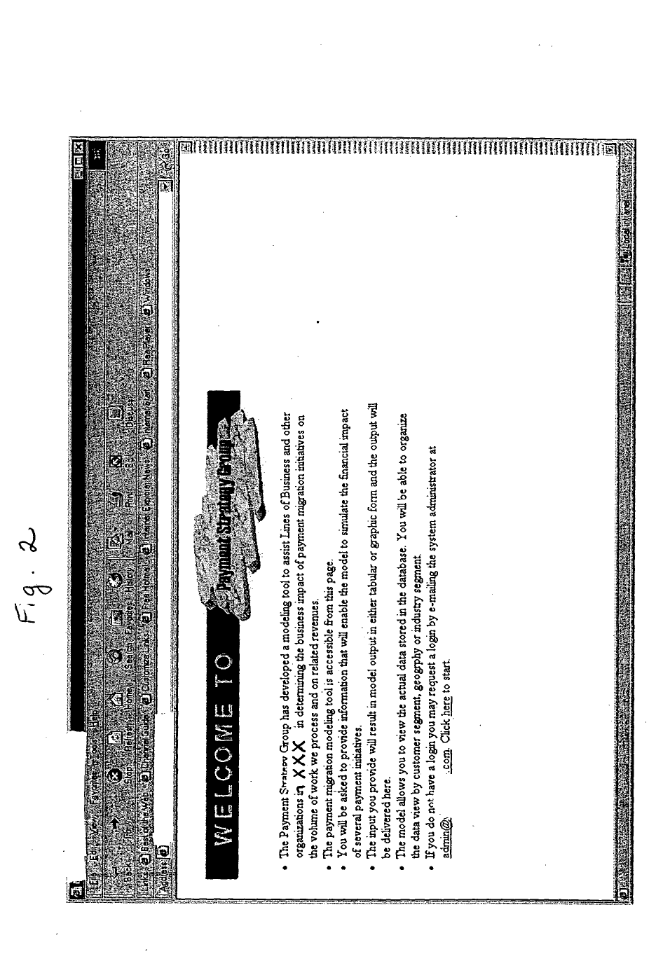

FIG. 2 is an example of a Welcome page for an interactive Web tool application. The Welcome Page is displayed upon entry to the application. For the user to continue past this page, the user must be defined to the applications security realm. The user is prompted for ID and password which is subsequently verified and used to determine if the user's role is application or administrator.

The first-time user is provided with a link to the model administrator for the purpose of requesting access to the model.

Sample Application User Pages.

Home Page

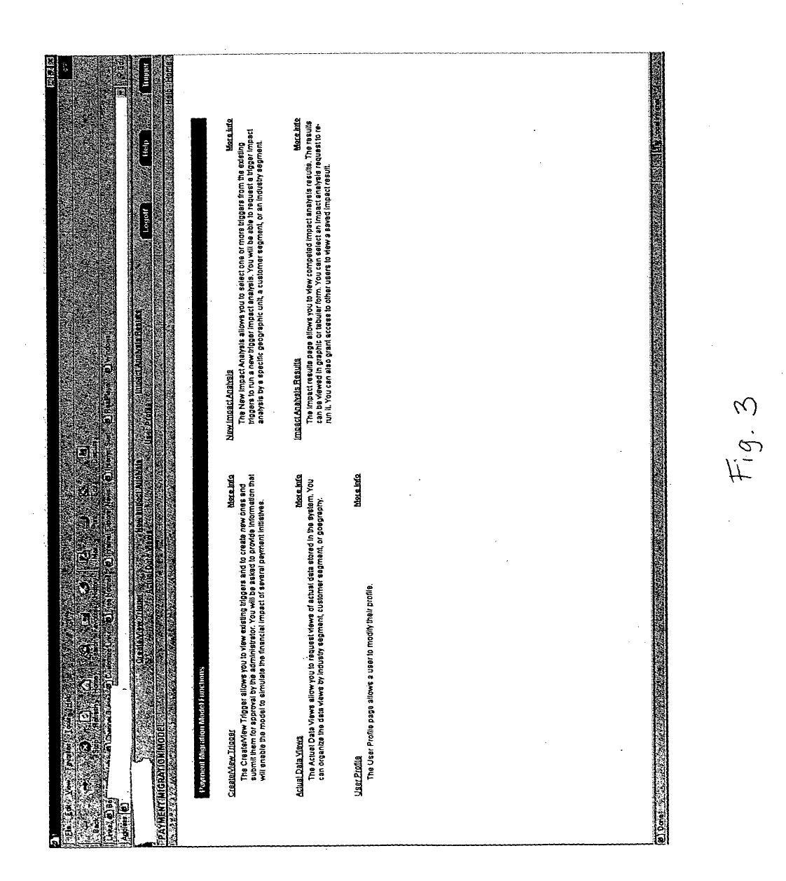

FIG. 3 is an example Home Page for the application user view (as opposed to for the administrator user view) and is presented to the user following application logon. This page presents the functions available to the application user. For ease of navigation these functions may be linked to throughout the application via the Toolbar frame. For application users, the User Profile link is made available for modifying user specific information.

Create/View Trigger Page

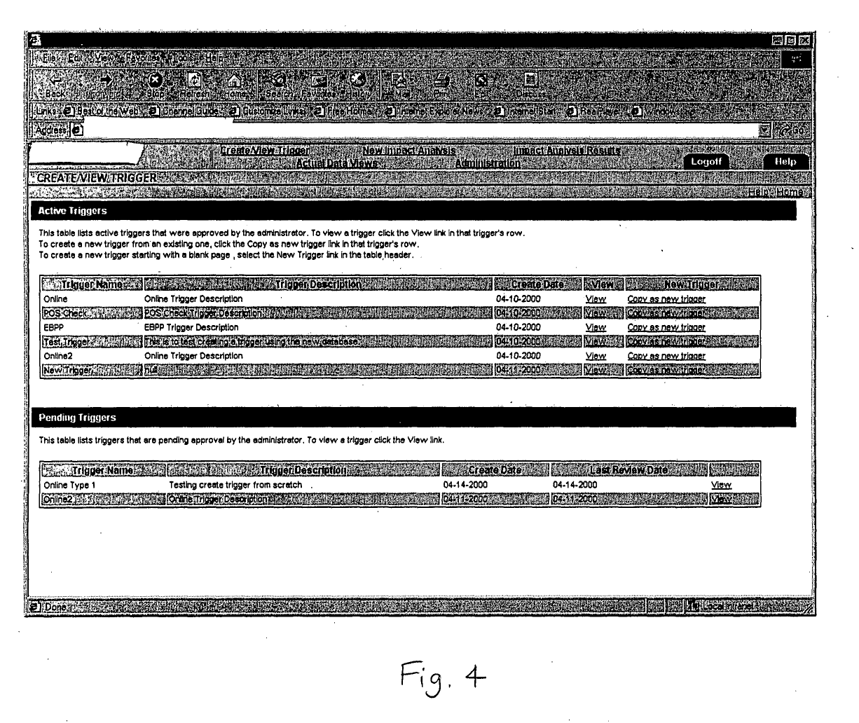

FIG. 4 is an example Create/View Trigger page providing means for creating new triggers, and viewing and maintaining existing triggers. A list of both existing Active and Pending Triggers is presented. From this page the user may perform the following functions:
Creating a new Trigger;
Viewing an existing Active Trigger;
Creating a new Trigger based upon the parameters of an existing Active Trigger; and
Viewing an existing Pending Trigger.

Trigger Detail Page

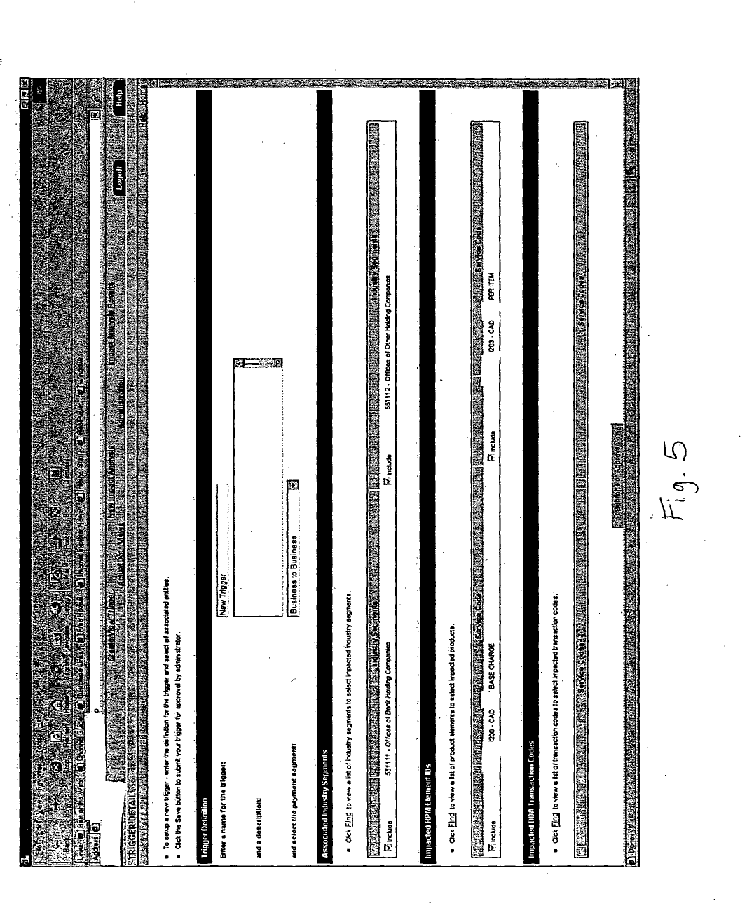

FIG. 5 is an example Trigger Detail page providing means for the user to create a new Trigger. The Trigger attributes and the relationships to the impacted industry segments, product element codes and transaction or service codes are entered. Creating a trigger is essentially a two-step process. After the page is complete, the user submits the newly created trigger for approval by the model administrator. Pending triggers are reviewed by the model administrator who may solicit input from other experts in the field to determine if the trigger is correct in form and that all impacted items are noted within the trigger. The trigger is then approved and made available for use in current and future analyses.

View Trigger Page

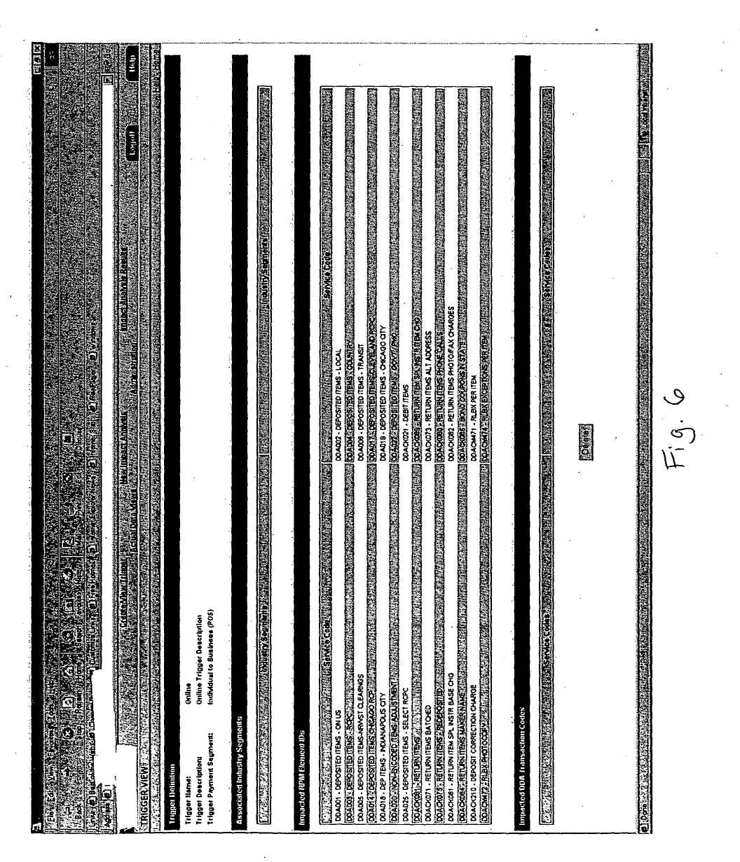

FIG. 6 is an example Trigger View page, providing means for the user to view the parameters of a particular active or pending trigger.

New Impact Analysis Request Page

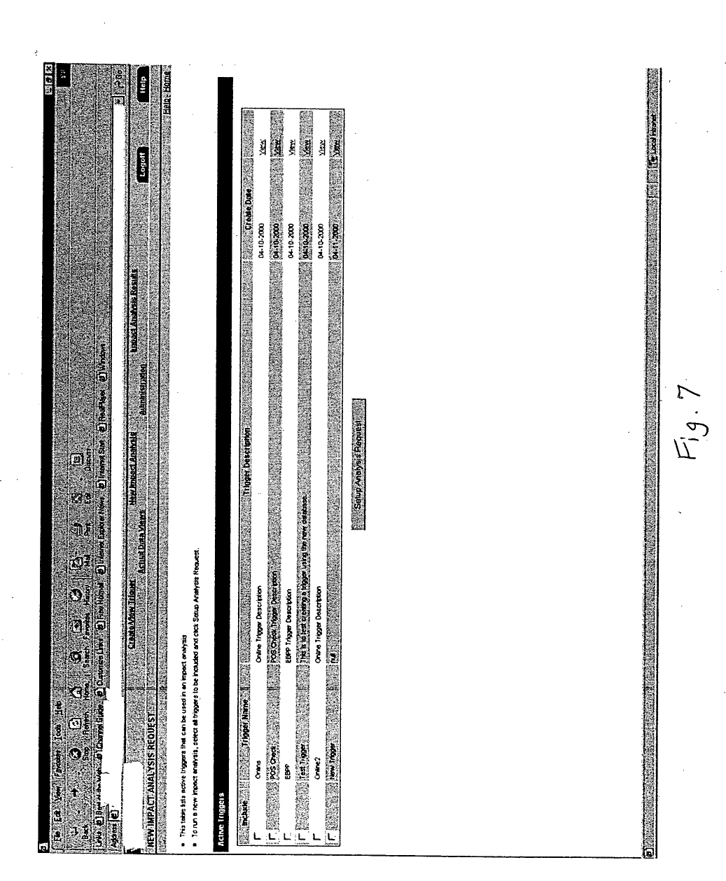

FIG. 7 is an example New Impact Analysis Request Page which presents a list of active triggers and provides the user with the following functions:
Setup a new analysis request by selecting one or more active triggers; and
View an Active Trigger.

Impact Analysis Request Page

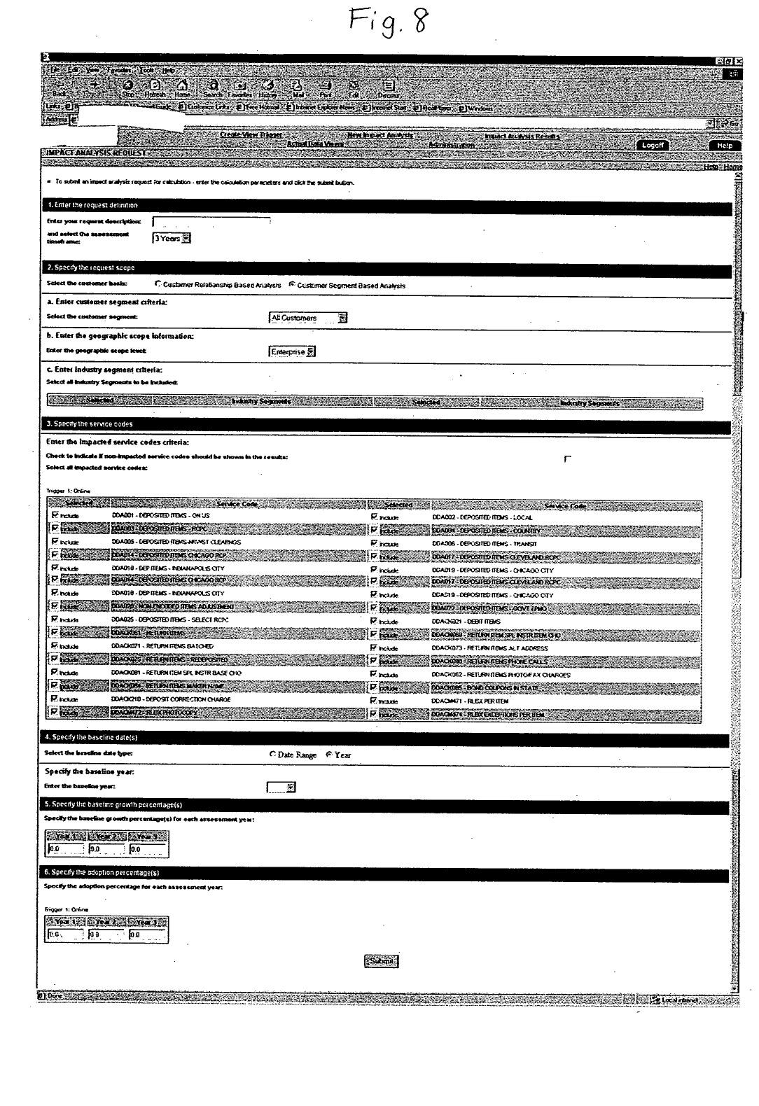

FIG. 8 is an example first Impact Analysis Request Page providing means for the user to specify the parameters for a new Impact Analysis Request. Following is an outline of example input parameters. Also, refer to FIG. 8.
The Analysis Request Definition
   Description—a description of the Analysis Request
   Assessment Timeframe—in years (1 to 5)
The Analysis Request Scope and Basis
   Customer Relationship Based Analysis
      Single customer relationships may be looked up based upon the relationship name or account number criteria
   Customer Segment Based Analysis
      The customer segment and geographic scope are selected. Examples of customer segment comprise but are not restricted to:
         All Customers
         Consumer
         Financial Institutions
         Small Business
         Wholesale
      Examples of geographic scope comprise but are not restricted to:
         Enterprise
         Region
         Bank
         Branch
The Impacted Service Codes
   Both impacted and non-impacted service codes may be selected for inclusion within the results
The Baseline Dates of the Analysis Request—either a year or date range
The Baseline Growth Percentages
The Adoption Percentages

Following the entry of the required parameters, the Impact Analysis Request may be submitted for processing.

Impact Analysis Request Page

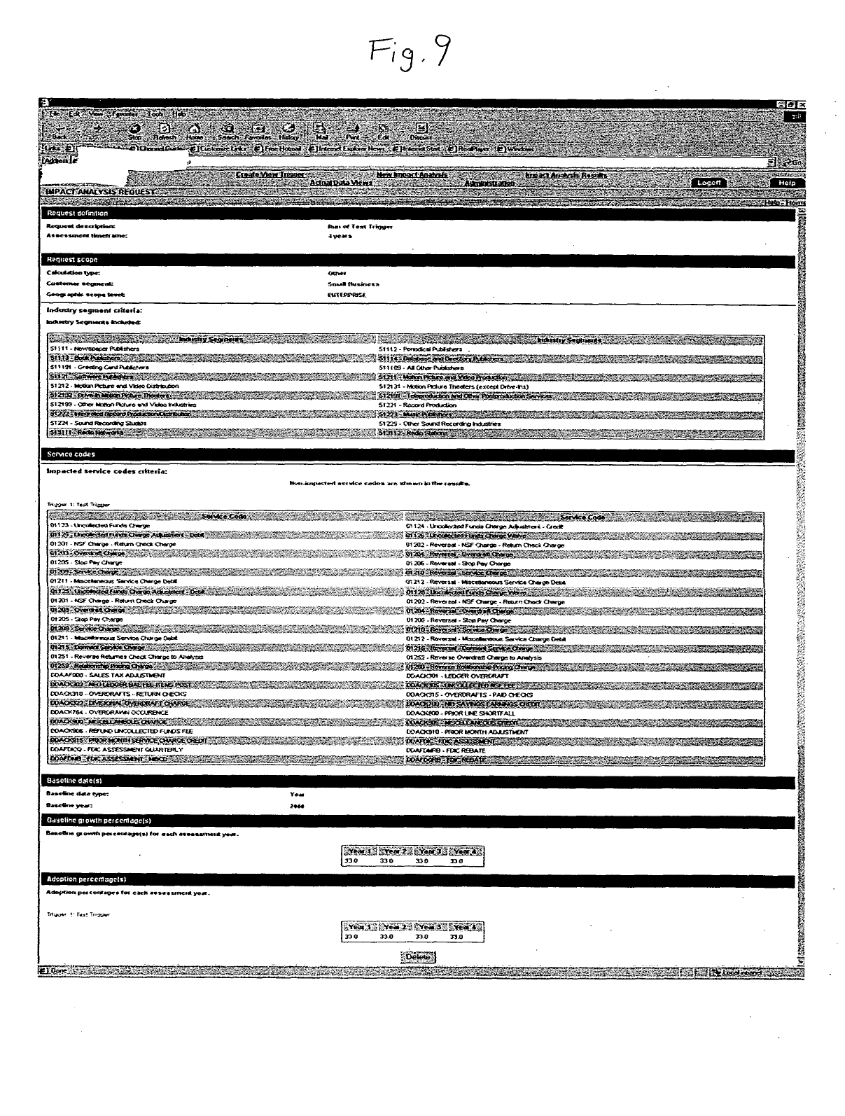

FIG. 9 is an example second Impact Analysis Request Page providing the user functionality to view and delete a previously submitted Impact Analysis Request.

Impact Analysis Request Results

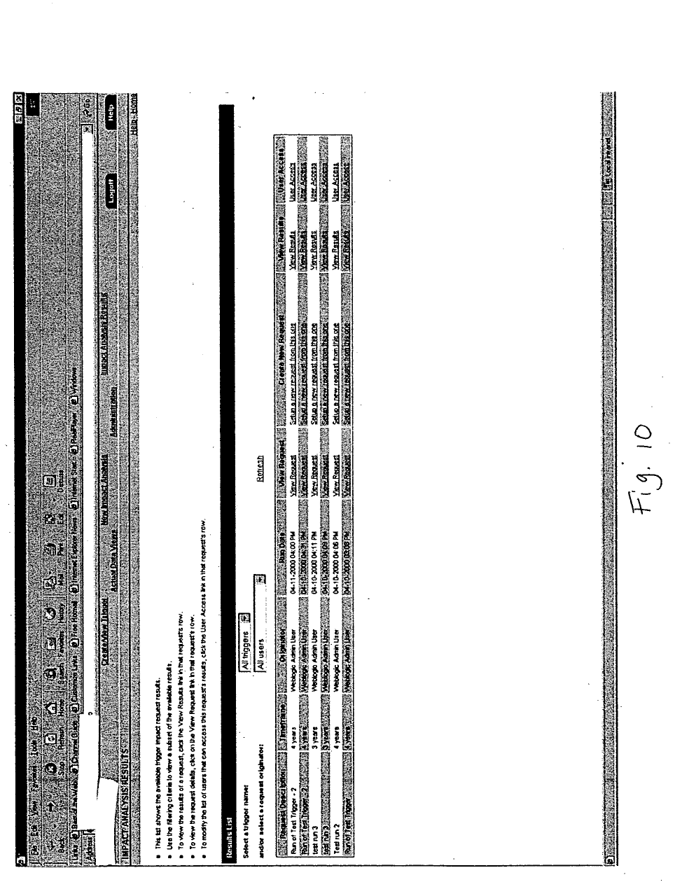

FIG. 10 is an example Impact Analysis Results Page which provides the user a list of processed Impact Analysis Requests. The user is provided the following functionality:
filtering the results list based on the Trigger Name and the requestor;
viewing the results for a selected request;
viewing the original request parameters;
providing user access to the results for viewing or modifying; and
setting up a new analysis request based upon the parameters of an existing one.

Impact Analysis Result Details Page

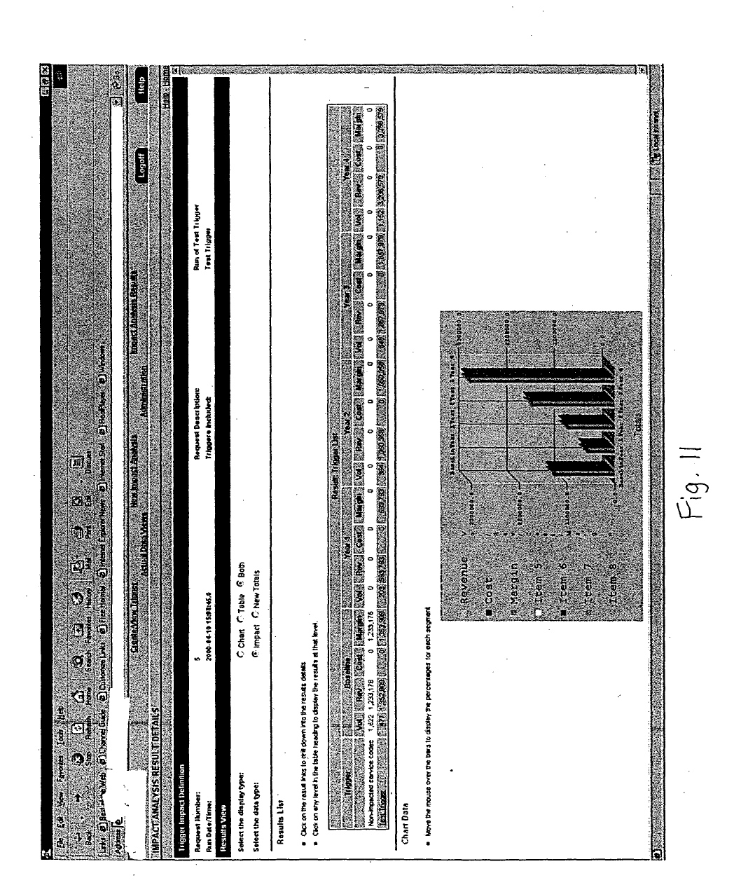

FIG. 11 is an example Impact Analysis Result Details Page providing means for allowing the user to view analysis results from either of two perspectives: incremental impact or new total.

The user can also choose one or both of the following view formats:
Graphical—the results are presented in a graphical bar chart form; and
Table—the results are presented in a traditional tabular form.

Trigger Results Users Page

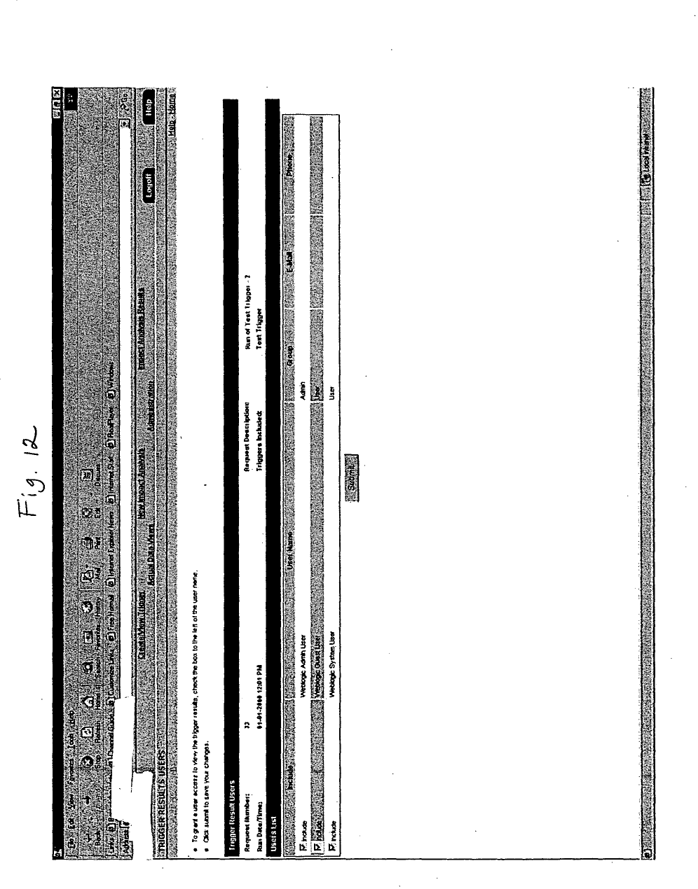

FIG. 12 is an example Trigger Results Users Page allowing the user to grant viewing permissions to other users of the application.

Actual Data Views Page

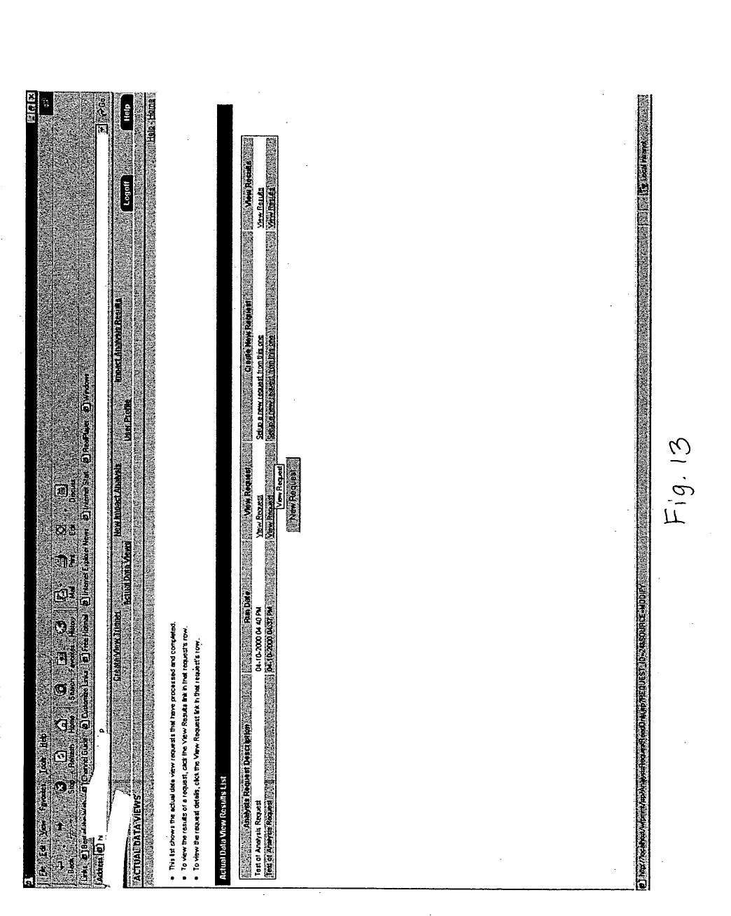

FIG. 13 is an example Actual Data Views Page providing a list of processed Data View Requests. From this page the user may perform the following actions:
View the original request parameters;
Setup a new Data View Request based on the parameters of an existing one;
View the results of a processed Data View Request; and
Setup a new Data View Request.

Actual Data View Request Detail Page

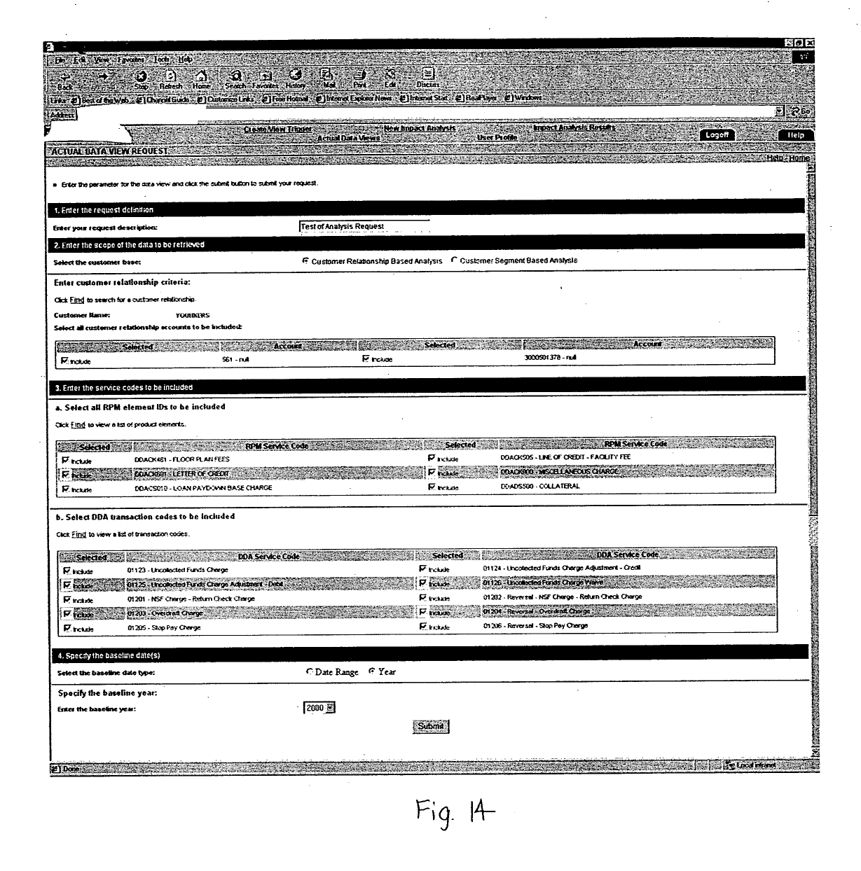

FIG. 14 is an example Actual Data View Request Detail page providing means for allowing the setup of a new Actual Data View Request. The Actual Data View Request Detail page allows the definition of a new Actual Data View Request.
The Actual Data View Request Definition
   Request Description—a description of the Actual Data View Request
The Actual Data View Request Scope
   Customer Relationship Based Actual Data View
      Single customer relationships may be looked up based upon the relationship names or account number criteria
   Customer Segment Based Actual Data View
      The Customer Segment and Geographic Scope is supplied. Examples of Customer segment comprise but are not restricted to:
         All Customers
         Consumer
         Financial Institutions
         Small Business
         Wholesale
      Examples of Geographic Scope comprise but are not restricted to:
         Enterprise
         Region
         Bank
         Branch
The Impacted Service Codes
The Baseline Dates of the Actual Data View Request
   Year based—a baseline year is required
   Date range based—start and end months and years are required, an option for specifying the results to be annualized is provided

Following the entry of the required parameters the Actual Data View Request may be submitted for processing.

Actual Data View Result Page

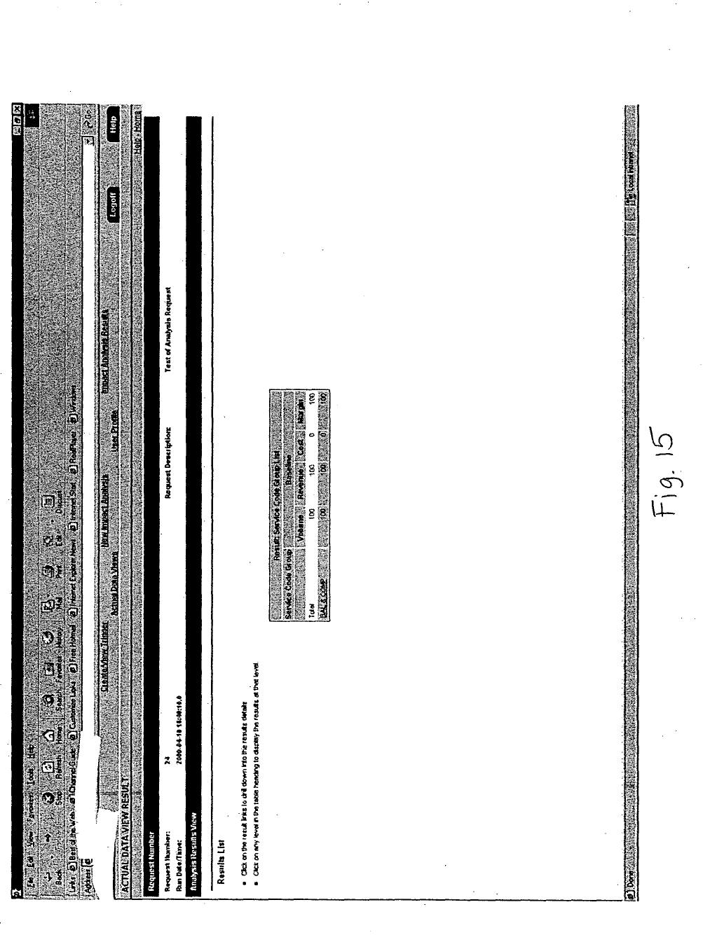

FIG. 15 is an example Actual Data View Result Page showing the results of a selected Actual Data View Request. The following information is presented:
Detail information relating to the description, date, and time and request number;
Summary Totals for Volume, Revenue, Cost, and Margin across service code groups; and
The service code group summary totals may be drilled down to their respective service code participants.

### Sample Application Administration Pages

Home Page—Administrator User View

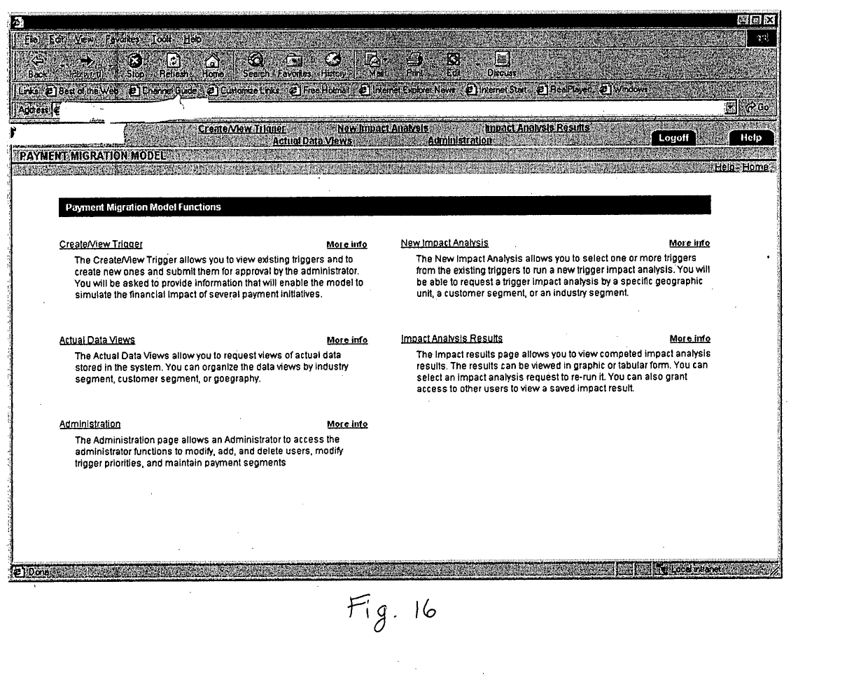

FIG. 16 is an example Home Page (Administrator user view) presented to the user following application logon. This page presents the functional subject areas within the application. For ease of navigation these functional areas may be linked to throughout the application via the toolbar frame. For administrators of the application, the Administration link is made available.

Administration Home Page

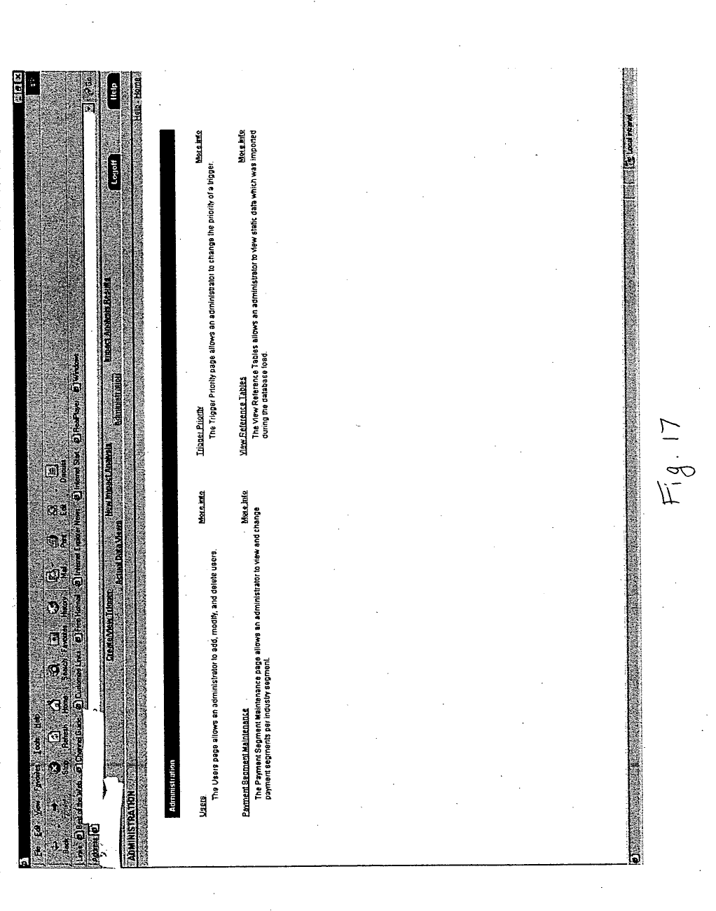

FIG. 17 is an example Administration Home Page for application administrators providing navigation to the following functionality:
User Administration;
Trigger Priority Maintenance;
Payment Segment Maintenance; and
Fixed Cost Maintenance.

Administration Users List Page

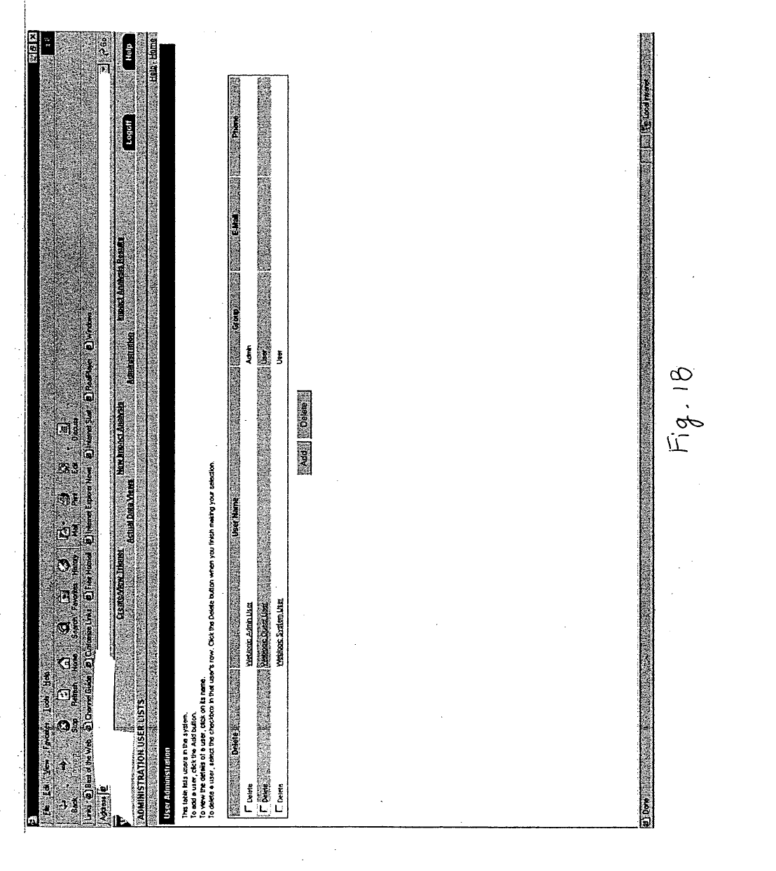

FIG. 18 is an example Administration Users List Page providing a list of all users defined to the application. From this page the following functions may be performed or linked to:
Setup of a new application user;
Deletion of an existing application user; and
View or maintenance of an existing application user.

Administration User Detail Page

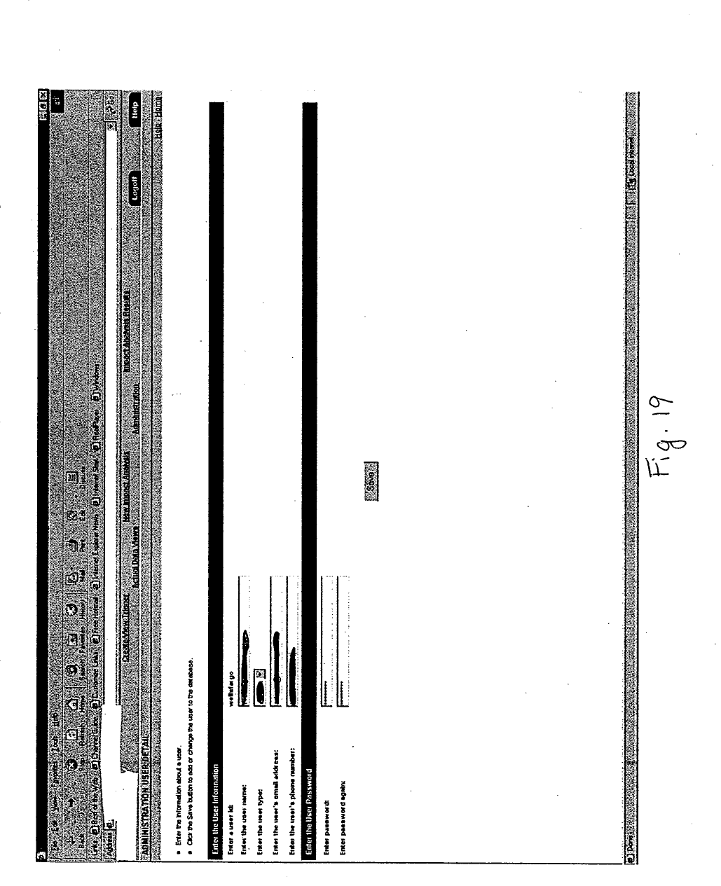

FIG. 19 is an example Administration User Detail page providing viewing and maintenance of an existing application user. It should be appreciated that the application supports users within different roles or types.

Administration Trigger Priority Page

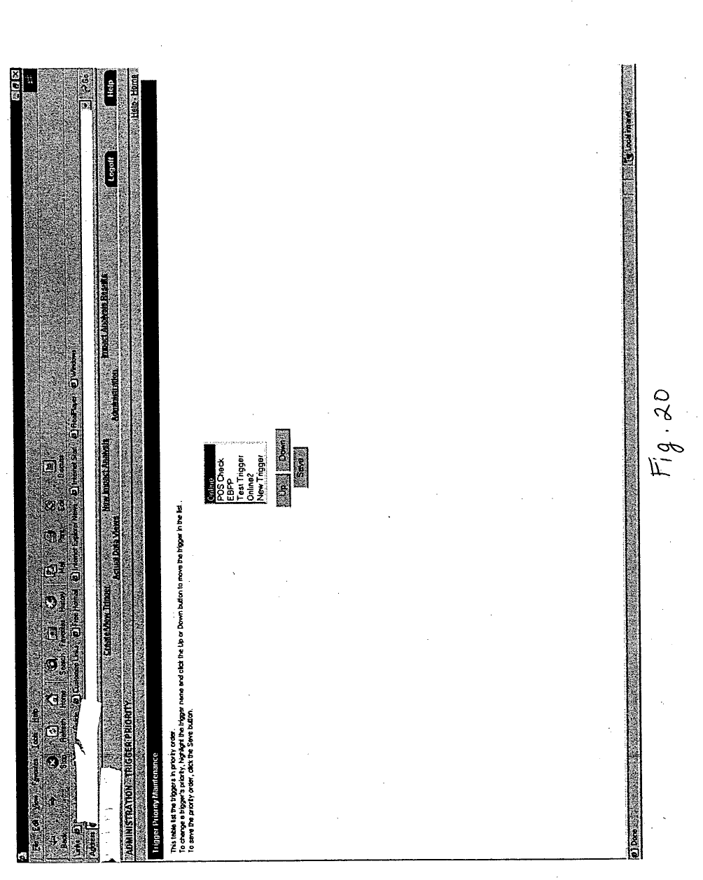

FIG. 20 is an example Trigger Priority Page providing functionality to reorder the priority of existing application triggers. Trigger priority is important if multiple triggers are used in the analysis, e.g. the trigger with the highest priority is applied and then the second priority applied to the remaining items and any new elements, etc.

Table A herein below is an example of the impact of two triggers, T1 and T2, in which T1 has a higher priority than T2.

TABLE A

| | Baseline | T1 Impact | T2 Impact | Remaining Results |
|---|---|---|---|---|
| Code 1 | 100 | 50% | 50% | 25 |
| Code 2 | 100 | 40% | 0% | 60 |
| Code 3 | 100 | 0% | 20% | 80 |

Administration Payment Segment Page

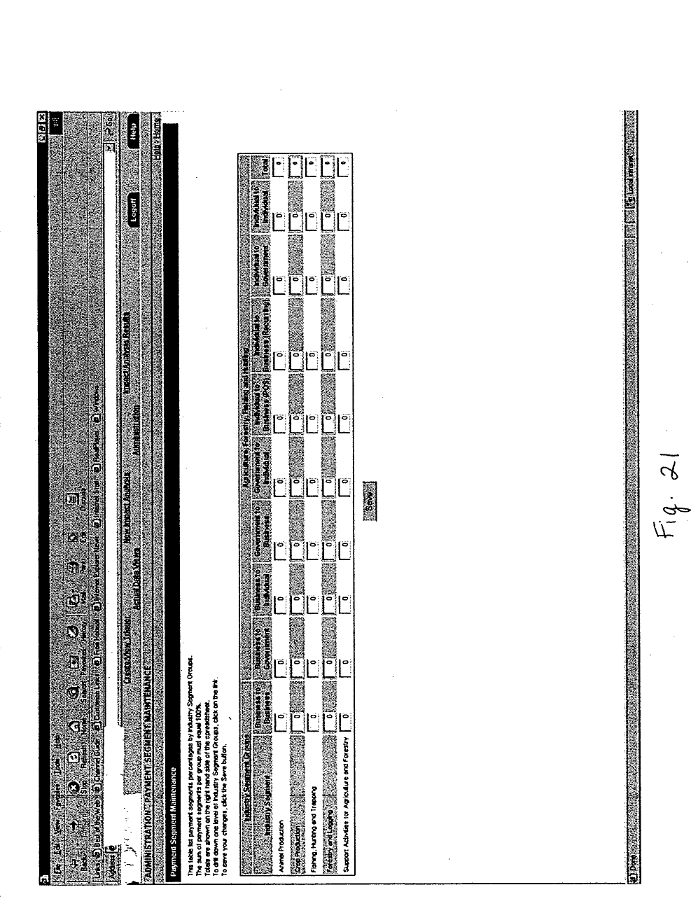

FIG. 21 is an example Administration Payment Segment Page providing viewing and maintenance of industry segment percentages within industry segment groups.

User Profile Page

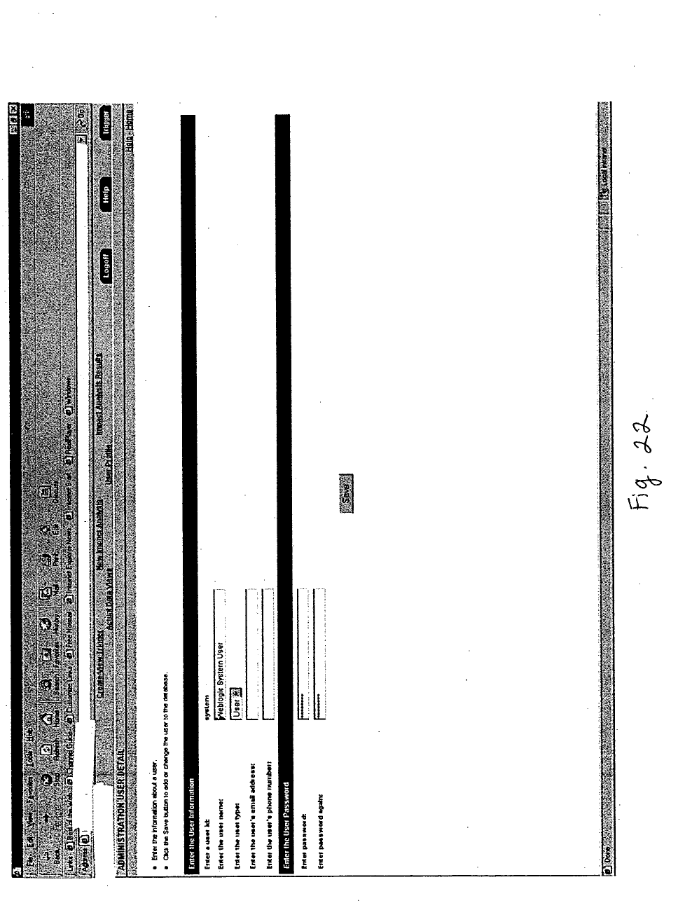

FIG. 22 is an example User Profile Page. In one embodiment of the invention, a user has administration status to maintain his or her profile information.

### SUMMARY

One preferred embodiment of the Migration Model is an interactive Web enabled data mining tool which allows the user to select form several predefined triggers as well as to specify the parameters for the analysis. New triggers can be added, but are first reviewed and approved by the model administrator.

When a user begins a new impact analysis the user is prompted to select one of many predefined triggers from a trigger table. The user can then select parameters, such as for example, growth rate, adoption rate, geographical location, type of business, etc., for each trigger selected. The user is allowed to select all customers, customers fitting into a sub set of customers, or any listing of customers including a customer set of one.

After processing, the results of the new impact analysis are presented to the user typically in graphical and/or data views. The user is further allowed to drill down into the parameters of the analysis for inspection.

Accordingly, although the invention has been described in detail with reference to particular preferred embodiments, persons possessing ordinary skill in the art to which this invention pertains will appreciate that various modifications and enhancements may be made without departing from the spirit and scope of the claims that follow.

1. An interactive tool for performing impact simulation and analysis, said tool comprising:
means for selecting one or more triggers from a set of at least one predefined trigger;
means for specifying parameters for each of said selected one or more triggers;
means for performing impact simulation and analysis using said selected one or more triggers and said specified parameters;
means for presenting results from said performed impact analysis; and
means for adding new triggers.

2. The tool of claim 1, wherein said tool is Web enabled.

3. The tool of claim 1, wherein said new triggers are first reviewed and approved by an administrator before being added.

4. The tool of claim 1, wherein said new triggers are based on said results.

5. An apparatus for performing impact analysis, said apparatus comprising:
a data warehouse for storing current environment information;
model defined rules and triggers used for processing data from said data warehouse;
a display means for a user to set and reset criteria coupled to said model defined rules and triggers;
an interactive transformation engine for performing impact analysis using any or all of said data from said data warehouse, said model defined rules and triggers, and said user defined criteria; and
means for providing output from said performed impact analysis on said interactive transformation engine.

6. The apparatus of claim 5, wherein said current environment information comprises transactional information.

7. The apparatus of claim 5, further comprising at least one system of record for having stored information on existing transactions and related infrastructure, said at least one system of record providing said stored information to said data warehouse.

8. The apparatus of claim 5, wherein said model defined rules and triggers comprise three fundamental dominant groups: categorization of groups of data; external evaluation parameters; and an iteration matrix.

9. The apparatus of claim 8, wherein said external evaluation parameters are applied to said categorization of groups.

10. The apparatus of claim 8, wherein said iteration matrix has trigger set up capability by indicating types of behavior with which said trigger interacts and how said trigger interact with other triggers.

11. The apparatus of claim 5, further comprising means for performing impact analysis iteratively based on any of:
results of a first cycle of said impact analysis;
added new triggers; and
reorganization of existing triggers.

12. The apparatus of claim 5, further comprising a knowledge management subsystem, whereby said apparatus gains knowledge with each trigger incorporated into said model defined rules and triggers.

13. A process for performing impact analysis, said process comprising the steps of:
providing a data warehouse for storing current environment information;
providing model defined rules and triggers used for processing data from said data warehouse;
providing a display means for a user to set and reset criteria coupled to said model defined rules and triggers;
providing an interactive transformation engine for performing impact analysis using any or all of said data from said data warehouse, said model defined rules and triggers, and said user defined criteria; and
providing output from said performed impact analysis on said interactive transformation engine.

14. The process of claim 13, wherein said current environment information comprises transaction information.

15. The process of claim 13, further comprising the step of providing at least one system of record for having stored information on existing transactions and related infrastructure, said at least one system of record providing said stored information to said data warehouse.

16. The process of claim 13, wherein said model defined rules and triggers comprise three fundamental dominant groups: categorization of groups of data; external evaluation parameters; and an iteration matrix.

17. The process of claim 16, wherein said external evaluation parameters are applied to said categorization of groups.

18. The process of claim 16, wherein said iteration matrix has trigger set up capability by indicating types of behavior with which said trigger interacts and how said trigger interact with other triggers.

19. The process of claim 13, further comprising the step of performing impact analysis iteratively based on any of:
results of a first cycle of said impact analysis;
added new triggers; and
reorganization of existing triggers.

20. The process of claim 13, further comprising the step of providing a knowledge management subsystem, whereby knowledge is gained with each trigger incorporated into said model defined rules and triggers.

21. An apparatus for performing impact analysis for an application user and for an application administrator, said apparatus comprising:
a trigger impact module; and
an actual data view module.

22. The apparatus of claim 21, wherein said trigger impact module provides means for assessing the impact of a trigger on a user defined data subset in accordance with user defined assumptions and parameters.

23. The apparatus of claim 21, further comprising a model database component, comprising a trigger table, said trigger table comprising active and pending triggers.

24. The apparatus of claim 22, wherein said triggers have attributes, said attributes comprising any of: a name, description, service codes, industry codes, product element codes, priority, and segments to which said trigger is mapped.

25. The apparatus of claim 23, wherein said actual data view module provides means for retrieving actual transaction data from said model database component by means of a query comprising user provided parameters, and wherein said actual data view module provides means for displaying a result of said query.

26. A process for performing impact analysis for an application user and for an application administrator, said method comprising the steps of:
providing a trigger impact module; and
providing an actual data view module.

27. The process of claim 26, wherein said trigger impact module provides means for assessing the impact of a trigger on a user defined data subset in accordance with user defined assumptions and parameters.

28. The process of claim 26, further comprising the step of providing a model database component, comprising a trigger table, said trigger table comprising active and pending triggers.

29. The process of claim 27, wherein said triggers have attributes, said attributes comprising any of: a name, description, service codes, industry codes, product element codes, priority, and segments to which said trigger is mapped.

30. The process of claim 28, wherein said actual data view module provides means for retrieving actual transaction data from said model database component by means of a query comprising user provided parameters, and wherein said actual data view module provides means for displaying a result of said query.
